(19) United States
(12) Patent Application Publication
(10) Pub. No.: US 2008/0228393 A1
(43) Pub. Date: Sep. 18, 2008

(54) Navigation device and method

(76) Inventors: Pieter Geelen, Amsterdam (NL); Serhiy Tkachenko, Amsterdam (NL)

Correspondence Address: TOMTOM INTERNATIONAL B.V., REMBRANDTPLEIN 35,, AMSTERDAM, 1017CT, NL

(21) Appl. No.: 12/007,376

(22) Filed: Jan. 9, 2008

Related U.S. Application Data
(60) Provisional application No. 60/879,584, filed on Jan. 10, 2007.

(51) Int. Cl. G01C 21/00

(52) U.S. Cl. 701/208

(57) ABSTRACT

A method of operating a navigation device, and a correspondingly adapted navigation device are described. The method includes the steps of representing stored map data visually on a display screen together with a graphical representation of the current device location, and is characterized by the further steps of determining a boundary distance forward and/or to one side of the current location of the device, determining from map data whether any ancillary elevation or landmark data is available within, or within a predetermined distance of, the boundary distance, such distance optionally being translated as may be appropriate to correspond to the map data, and causing display of one or more graphical visualizations representing elevated features or landmarks in conjunction with the visually represented map data.

### PRIORITY STATEMENT

The present application hereby claims priority under 35 U.S.C. § 119(e) on U.S. Provisional Patent Application No. 60/879,584 filed Jan. 10, 2007, the entire contents of which is hereby incorporated herein by reference.

### FIELD OF THE INVENTION

This invention relates to an improved navigation device and method.

Although the following description relates primarily to portable navigation devices (PNDs), it will be instantly appreciated by the reader that the invention is equally applicable to navigation systems being comprised of the same intrinsic functional components, but which are generally integrated into the body of some larger vehicle and are thus not generally removable therefrom. A navigation device, as the term is used hereinafter, is intended to cover both PNDs and navigation systems, and the description hereinafter provided relating to PNDs will be found equally applicable to navigation systems.

### BACKGROUND OF THE INVENTION

PNDs including GPS (Global Positioning System) signal reception and processing means are known and are widely employed for in-car navigation. In essence, modern PNDs comprise:
a processor,
memory (at least one of volatile and non-volatile, and commonly both),
map data stored within said memory,
a software operating system and optionally one or more additional programs executing thereon, to control the functionality of the device and provide various features,
a GPS antenna by which satellite-broadcast signals including location data can be received and subsequently processed to determine a current location of the device,
optionally, electronic gyroscopes and accelerometers which produce signals capable of being processed to determine the current angular and linear acceleration, and in turn, and in conjunction with location information derived from the GPS signal, velocity and relative displacement of the device and thus the vehicle in which it is mounted,
input and output means, examples including a visual display (which may be touch sensitive to allow for user input), one or more physical buttons to control on/off operation or other features of the device, a speaker for audible output,
optionally one or more physical connectors by means of which power and optionally one or more data signals can be transmitted to and received from the device, and
optionally one or more wireless transmitters/receivers to allow communication over mobile telecommunications and other signal and data networks, for example Wi-Fi, Wi-Max GSM and the like.

The utility of the PND is manifested primarily in its ability to determine a route between a start or current location and a destination, which can be input by a user of the computing device, by any of a wide variety of different methods, for example by postcode, street name and number, and previously stored well known, favourite or recently visited destinations. Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice. In addition, the device may continually monitor road and traffic conditions, and offer to or choose to change the route over which the remainder of the journey is to be made due to changed conditions. Real time traffic monitoring systems, based on various technologies (e.g. mobile phone calls, fixed cameras, GPS fleet tracking) are being used to identify traffic delays and to feed the information into notification systems.

The navigation device may typically be mounted on the dashboard of a vehicle, but may also be formed as part of an on-board computer of the vehicle or car radio. The navigation device may also be (part of) a hand-held system, such as a PDA (Personal Navigation Device) a media player, a mobile phone or the like, and in these cases, the normal functionality of the hand-held system is extended by means of the installation of software on the device to perform both route calculation and navigation along a calculated route. In any event, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and the navigation along such a route is another primary function. During navigation along a calculated route, the PND provides visual and/or audible instructions to guide the user along a chosen route to the end of that route, that is the desired destination. It is usual for PNDs to display map information on-screen during the navigation, such information regularly being updated on-screen so that the map information displayed is representative of the current location of the device, and thus of the user or user's vehicle if the device is being used for in-car navigation. An icon displayed on-screen typically denotes the current device location, and is centred with the map information of current and surrounding roads and other map features being also displayed. Additionally, navigation information may be displayed, optionally in a status bar above, below or to one side of the displayed map information, examples of navigation information including the distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated a simple instruction such as “turn left in 100 m” requires significant processing and analysis. As previously mentioned, user interaction with the device may be by a touch screen, or additionally or alternately by steering column mounted remote control, by voice activation or by any other suitable method.

A further important function provided by the device is automatic route re-calculation in the event that
a user deviates from the previously calculated route during navigation therealong,
real-time traffic conditions dictate that an alternative route would be more expedient and the device is suitably enabled to recognize such conditions automatically, or
if a user actively causes the device to perform route re-calculation for any reason.

It is also known to allow a route to be calculated with user defined criteria; for example, the user may prefer a scenic route to be calculated by the device, or may wish to avoid any roads on which traffic congestion is likely, expected or currently prevailing. The device software would then calculate various routes and weigh more favourably those that include along their route the highest number of points of interest (known as POIs) tagged as being for example of scenic beauty, or, using stored information indicative of prevailing traffic conditions on particular roads, order the calculated routes in terms of a level of likely congestion or delay on account thereof. Other POI-based and traffic information-based route calculation and navigation criteria are also possible.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

In either of a navigation or free-driving mode of operation the nature of map information displayed is currently relatively basic, and includes only basic color coding of roads of different types and non-road areas, basic textual information identifying the current and other relatively proximate roads, and optionally one or more icons identifying certain categories of POI previously approved by the user for display. Although there are good reasons for keeping the display of map information as basic as possible, such as the increased resources in terms of processing power required and the need to retain simplicity of display to aid a user's speed of recognition of the matter being displayed, there are certain features which might be displayed which would immediately enhance the user's speed of recognition. Ideally, in the case where processing power was of no concern and display capabilities were limitless, the ideal display would be a digital high resolution representation of the view currently seen by the user wherever she might be, such continuously changing as the device moved, but of course this is currently not achievable, and therefore a basic graphical representation of information is currently adopted.

In terms of map data currently available, map data providers often provide a significant amount of ancillary data together with the base map data, the latter essentially encompassing roads, their identification, their type, and possibly an access or travel direction for those identified roads. Such ancillary information can include a vast array of different data including altitude data, road physical properties, surrounding landscape data, landmark identification possibly enhanced by digital photographic representations thereof, POI data, urban and rural area identification, particularized by village, city, town, and the like, information airports and other municipal transport forms excepting the road network. Of course, many more types of ancillary information may be available, either as part of the total map data file or files stored in the memory of the device or system or as supplemental map data files which may be downloaded or otherwise applied to the total map data at any time subsisting in the device or system memory so as to augment that map data. In some cases, PNDs often only contain a reduced version of the total map data available on account of the need to conserve storage space within the device, although this restriction is gradually being lifted as memory becomes less expensive and more compact.

For example, currently the map data is displayed on screen in a manner, either 2- or 3-dimensionally, which does not represent the physical properties of roads and the surrounding landscape. In particular, in hilly areas where there is very little information displayed, or in busy cities where there is very little time to make decisions on account of traffic density, it is possible for users to be mislead or confused.

It is already known to store road network elevation data (of use for example where roads of differing elevations pass over or under one another),

It is an object of this invention to provide enhanced information display and visualizations on a display screen of a PND or navigation system utilizing more of the ancillary data available from map data and which is achievable without placing significant additional burden on the processor provided or associated with such devices or systems, and which enhances the information displayed on-screen either in terms of aesthetics, comprehensibility, recognizability or its ability to improve a user's ability to orientate themselves by referring to the device in the event that they become disorientated.

It is a further object of the present invention to provide a PND or navigation system, a method of operating such, and a computer program by means of which the first object is possible.

### BRIEF SUMMARY OF THE INVENTION

According to the present invention, there is provided a method of operating a navigation device, said method including the steps of representing stored map data visually on a display screen and including graphical representation of the current device location, and characterized by the further steps of

determining a boundary distance forward and/or to one side of the current location of the device,
determining from map data whether any ancillary elevation or landmark data is available within the boundary distance, translated as may be appropriate to correspond to the map data, and
causing display of one or more graphical visualizations representing elevated features or landmarks.

Preferably, the display of one or more graphical visualizations is effected in the event that ancillary elevation or landmark data, derived from map data, are either
within the boundary distance
within the boundary distance and within a predetermined distance of the current device location,
outside the boundary distance by a predetermined amount and greater than a predetermined elevation level.

Preferably the graphical visualization is applied to the displayed map data above a horizon level appearing on the screen of the device, and further preferably is in the form of mountains.

Preferably alternately or additionally, in the event that elevation data is available for one or more features currently being displayed, and is sufficiently different from the elevation of the current location of the device, the graphical visualization takes the form of shading over and around that area or feature within the map data for which elevation data is available.

Further preferably, in the event that landmark data is available for one or more locations being within the region defined of the currently displayed map data, and within a predetermined distance of the current device location, the graphical visualization takes the form of an icon or other graphical indicator having a shape or otherwise generally being representative of the landmark, in particular being of a shape generally corresponding to the actual landmark shape.

In a preferred embodiment, the map data (or one or more supplemental files thereof) contains photographic data for one or more of the landmarks represented within one or more physical geographic regions covered by the map data, the method including the step of displaying the photographic image data at the appropriate position on the screen of the device, preferably having been resized as appropriate for the current zoom level, and further preferably having had additional processing applied thereto such that the photographic image appears at least partially blended into the underlying, currently displayed map data.

Preferably, the blending technique is an alpha-blending or alpha-compositing technique, or other technique wherein the landmark photographic image transparency and/or colour composition is adjusted to more appropriately match the underlying currently displayed map data.

Most preferably, the landmark data is in the form of approximated shape information, for example by being represented using one or more known mathematical methods such as splines, parameterized sin( ) waves, in order to minimize memory resource requirements within the device.

In a preferred embodiment, the device may also stored a set of predefined textures which may be applied as part of the graphical visualizations displayed on screen, being one of (for example) “forest”, “rock”, “building”, “greenery”, “roof”, “mountain”, and the like.

In an alternative aspect of the invention, there is provided a method of operating a navigation device, said method including the steps of representing stored map data visually on a display screen and including graphical representation of the current device location, and

characterized by the further steps of
determining a current directional orientation of the device based on recent movement thereof,
determining an approximate position of a celestial body being one of the sun, the moon, and one or more stars with reference to the current device location and orientation, and displaying some graphical indication on the screen of the device representative of the determined position of said celestial body.

In further aspects of the invention, a computer program, embodied on computer readable media as required, is provided for implementing the methods described above, as is a PND and/or navigation system adapted to perform the methods described.

### BRIEF DESCRIPTION OF THE DRAWINGS

The present application will be described in more detail below by using example embodiments, which will be explained with the aid of the drawings, in which:

FIG. 1 illustrates an example view of a Global Positioning System (GPS);

FIG. 2 illustrates an example block diagram of electronic components of a navigation device;

FIG. 3 illustrates an example block diagram of the manner in which a navigation device may receive information over a wireless communication channel;

FIGS. 4A and 4B are perspective views of an implementation of an embodiment of the navigation device;

FIGS. 5-8 show screenshots from a portable navigation device in a navigation mode in which the graphical visualizations of the invention are displayed in conjunction with map data.

### DETAILED DESCRIPTION

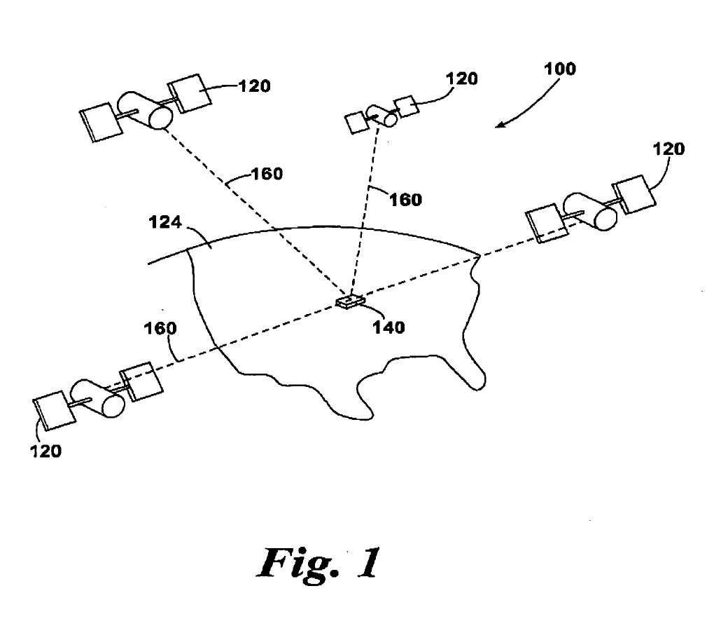

FIG. 1 illustrates an example view of Global Positioning System (GPS), usable by navigation devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which work with the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

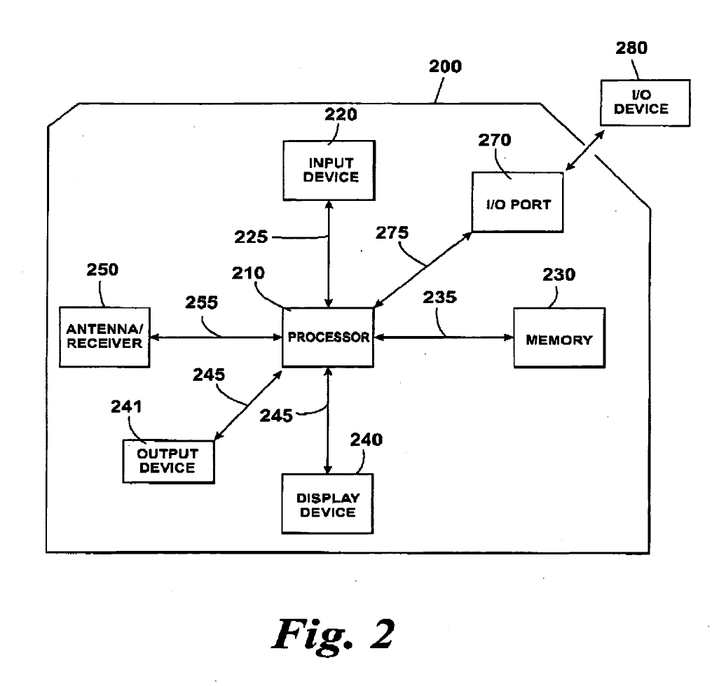

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner. FIG. 2 illustrates an example block diagram of electronic components of a navigation device 200, in block component format. It should be noted that the block diagram of the navigation device 200 is not inclusive of all components of the navigation device, but is only representative of many example components.

The navigation device 200 is located within a housing (not shown). The housing includes a processor 210 connected to an input device 220 and a display screen 240. The input device 220 can include a keyboard device, voice input device, touch panel and/or any other known input device utilized to input information; and the display screen 240 can include any type of display screen such as an LCD display, for example. The input device 220 and display screen 240 are integrated into an integrated input and display device, including a touchpad or touchscreen input wherein a user need only touch a portion of the display screen 240 to select one of a plurality of display choices or to activate one of a plurality of virtual buttons.

In addition, other types of output devices 250 can also include, including but not limited to, an audible output device. As output device 241 can produce audible information to a user of the navigation device 200, it is equally understood that input device 240 can also include a microphone and software for receiving input voice commands as well. In the navigation device 200, processor 210 is operatively connected to and set to receive input information from input device 240 via a connection 225, and operatively connected to at least one of display screen 240 and output device 241, via output connections 245, to output information thereto. Further, the processor 210 is operatively connected to memory 230 via connection 235 and is further adapted to receive/send information from/to input/output (I/O) ports 270 via connection 275, wherein the I/O port 270 is connectible to an I/O device 280 external to the navigation device 200. The external I/O device 270 may include, but is not limited to an external listening device such as an earpiece for example. The connection to I/O device 280 can further be a wired or wireless connection to any other external device such as a car stereo unit for hands-free operation and/or for voice activated operation for example, for connection to an ear piece or head phones, and/or for connection to a mobile phone for example, wherein the mobile phone connection may be used to establish a data connection between the navigation device 200 and the internet or any other network for example, and/or to establish a connection to a server via the internet or some other network for example.

The navigation device 200 may establish a “mobile” or telecommunications network connection with the server 302 via a mobile device 400 (such as a mobile phone, PDA, and/or any device with mobile phone technology) establishing a digital connection (such as a digital connection via known Bluetooth technology for example). Thereafter, through its network service provider, the mobile device 400 can establish a network connection (through the internet for example) with a server 302. As such, a “mobile” network connection is established between the navigation device 200 (which can be, and often times is mobile as it travels alone and/or in a vehicle) and the server 302 to provide a “real-time” or at least very “up to date” gateway for information.

The establishing of the network connection between the mobile device 400 (via a service provider) and another device such as the server 302, using the internet 410 for example, can be done in a known manner. This can include use of TCP/IP layered protocol for example. The mobile device 400 can utilize any number of communication standards such as CDMA, GSM, WAN, etc.

As such, an internet connection may be utilized which is achieved via data connection, via a mobile phone or mobile phone technology within the navigation device 200 for example. For this connection, an internet connection between the server 302 and the navigation device 200 is established. This can be done, for example, through a mobile phone or other mobile device and a GPRS (General Packet Radio Service)-connection (GPRS connection is a high-speed data connection for mobile devices provided by telecom operators; GPRS is a method to connect to the internet.

The navigation device 200 can further complete a data connection with the mobile device 400, and eventually with the internet 410 and server 302, via existing Bluetooth technology for example, in a known manner, wherein the data protocol can utilize any number of standards, such as the GSRM, the Data Protocol Standard for the GSM standard, for example.

The navigation device 200 may include its own mobile phone technology within the navigation device 200 itself (including an antenna for example, wherein the internal antenna of the navigation device 200 can further alternatively be used). The mobile phone technology within the navigation device 200 can include internal components as specified above, and/or can include an insertable card (e.g. Subscriber Identity Module or SIM card), complete with necessary mobile phone technology and/or an antenna for example. As such, mobile phone technology within the navigation device 200 can similarly establish a network connection between the navigation device 200 and the server 302, via the internet 410 for example, in a manner similar to that of any mobile device 400.

For GRPS phone settings, the Bluetooth enabled device may be used to correctly work with the ever changing spectrum of mobile phone models, manufacturers, etc., model/manufacturer specific settings may be stored on the navigation device 200 for example. The data stored for this information can be updated.

FIG. 2 further illustrates an operative connection between the processor 210 and an antenna/receiver 250 via connection 255, wherein the antenna/receiver 250 can be a GPS antenna/receiver for example. It will be understood that the antenna and receiver designated by reference numeral 250 are combined schematically for illustration, but that the antenna and receiver may be separately located components, and that the antenna may be a GPS patch antenna or helical antenna for example.

Further, it will be understood by one of ordinary skill in the art that the electronic components shown in FIG. 2 are powered by power sources (not shown) in a conventional manner. As will be understood by one of ordinary skill in the art, different configurations of the components shown in FIG. 2 are considered within the scope of the present application. For example, the components shown in FIG. 2 may be in communication with one another via wired and/or wireless connections and the like. Thus, the scope of the navigation device 200 of the present application includes a portable or handheld navigation device 200.

In addition, the portable or handheld navigation device 200 of FIG. 2 can be connected or “docked” in a known manner to a motorized vehicle such as a car or boat for example. Such a navigation device 200 is then removable from the docked location for portable or handheld navigation use.

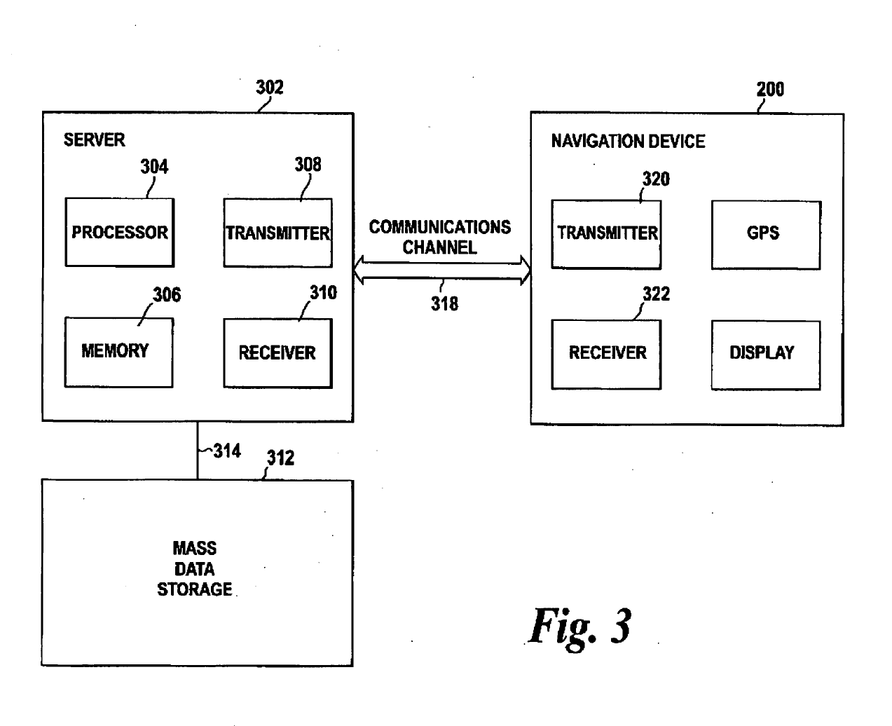

FIG. 3 illustrates an example block diagram of a server 302 and a navigation device 200 capable of communicating via a generic communications channel 318. The server 302 and a navigation device 200 can communicate when a connection via communications channel 318 is established between the server 302 and the navigation device 200-(noting that such a connection can be a data connection via mobile device, a direct connection via personal computer via the internet, etc.).

The server 302 includes, in addition to other components which may not be illustrated, a processor 304 operatively connected to a memory 306 and further operatively connected, via a wired or wireless connection 314, to a mass data storage device 312. The processor 304 is further operatively connected to transmitter 308 and receiver 310, to transmit and send information to and from navigation device 200 via communications channel 318. The signals sent and received may include data, communication, and/or other propagated signals. The transmitter 308 and receiver 310 may be selected or designed according to the communications requirement and communication technology used in the communication design for the navigation system 200. Further, it should be noted that the functions of transmitter 308 and receiver 310 may be combined into a signal transceiver. Server 302 is further connected to (or includes) a mass storage device 312, noting that the mass storage device 312 may be coupled to the server 302 via communication link 314. The mass storage device 312 contains a store of navigation data and map information, and can again be a separate device from the server 302 or can be incorporated into the server 302.

The navigation device 200 is adapted to communicate with the server 302 through communications channel 318, and includes processor, memory, etc. as previously described with regard to FIG. 2, as well as transmitter 320 and receiver 322 to send and receive signals and/or data through the communications channel 318, noting that these devices can further be used to communicate with devices other than server 302. Further, the transmitter 320 and receiver 322 are selected or designed according to communication requirements and communication technology used in the communication design for the navigation device 200 and the functions of the transmitter 320 and receiver 322 may be combined into a single transceiver.

Software stored in server memory 306 provides instructions for the processor 304 and allows the server 302 to provide services to the navigation device 200. One service provided by the server 302 involves processing requests from the navigation device 200 and transmitting navigation data from the mass data storage 312 to the navigation device 200. Another service provided by the server 302 includes processing the navigation data using various algorithms for a desired application and sending the results of these calculations to the navigation device 200.

The communication channel 318 generically represents the propagating medium or path that connects the navigation device 200 and the server 302. Both the server 302 and navigation device 200 include a transmitter for transmitting data through the communication channel and a receiver for receiving data that has been transmitted through the communication channel.

The communication channel 318 is not limited to a particular communication technology. Additionally, the communication channel 318 is not limited to a single communication technology; that is, the channel 318 may include several communication links that use a variety of technology. For example, the communication channel 318 can be adapted to provide a path for electrical, optical, and/or electromagnetic communications, etc. As such, the communication channel 318 includes, but is not limited to, one or a combination of the following: electric circuits, electrical conductors such as wires and coaxial cables, fiber optic cables, converters, radio-frequency (rf) waves, the atmosphere, empty space, etc. Furthermore, the communication channel 318 can include intermediate devices such as routers, repeaters, buffers, transmitters, and receivers, for example.

For example, the communication channel 318 includes telephone and computer networks. Furthermore, the communication channel 318 may be capable of accommodating wireless communication such as radio frequency, microwave frequency, infrared communication, etc. Additionally, the communication channel 318 can accommodate satellite communication.

The communication signals transmitted through the communication channel 318 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 318. These signals may be modulated, encrypted and/or compressed signals as may be desirable for the communication technology.

The server 302 includes a remote server accessible by the navigation device 200 via a wireless channel. The server 302 may include a network server located on a local area network (LAN), wide area network (WAN), virtual private network (VPN), etc.

The server 302 may include a personal computer such as a desktop or laptop computer, and the communication channel 318 may be a cable connected between the personal computer and the navigation device 200. Alternatively, a personal computer may be connected between the navigation device 200 and the server 302 to establish an internet connection between the server 302 and the navigation device 200. Alternatively, a mobile telephone or other handheld device may establish a wireless connection to the internet, for connecting the navigation device 200 to the server 302 via the internet.

The navigation device 200 may be provided with information from the server 302 via information downloads which may be periodically updated upon a user connecting navigation device 200 to the server 302 and/or may be more dynamic upon a more constant or frequent connection being made between the server 302 and navigation device 200 via a wireless mobile connection device and TCP/IP connection for example. For many dynamic calculations, the processor 304 in the server 302 may be used to handle the bulk of the processing needs, however, processor 210 of navigation device 200 can also handle much processing and calculation, oftentimes independent of a connection to a server 302.

As indicated above in FIG. 2, a navigation device 200 includes a processor 210, an input device 220, and a display screen 240. The input device 220 and display screen 240 are integrated into an integrated input and display device to enable both input of information (via direct input, menu selection, etc.) and display of information through a touch panel screen, for example. Such a screen may be a touch input LCD screen, for example, as is well known to those of ordinary skill in the art. Further, the navigation device 200 can also include any additional input device 220 and/or any additional output device 241, such as audio input/output devices for example.

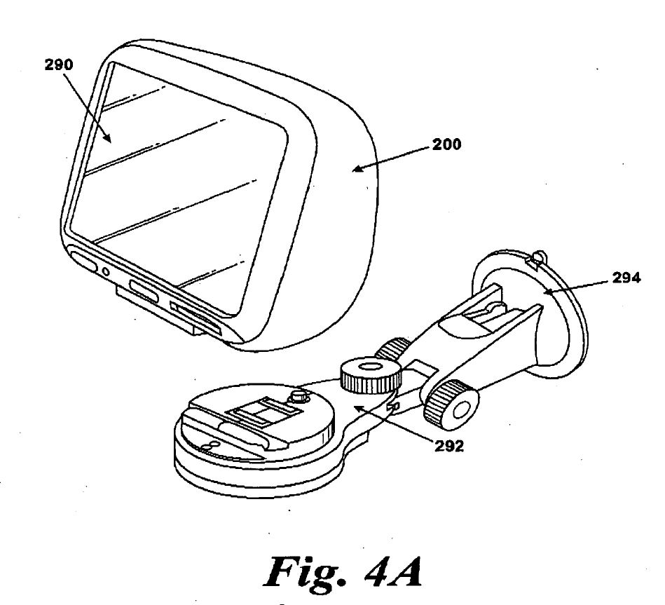

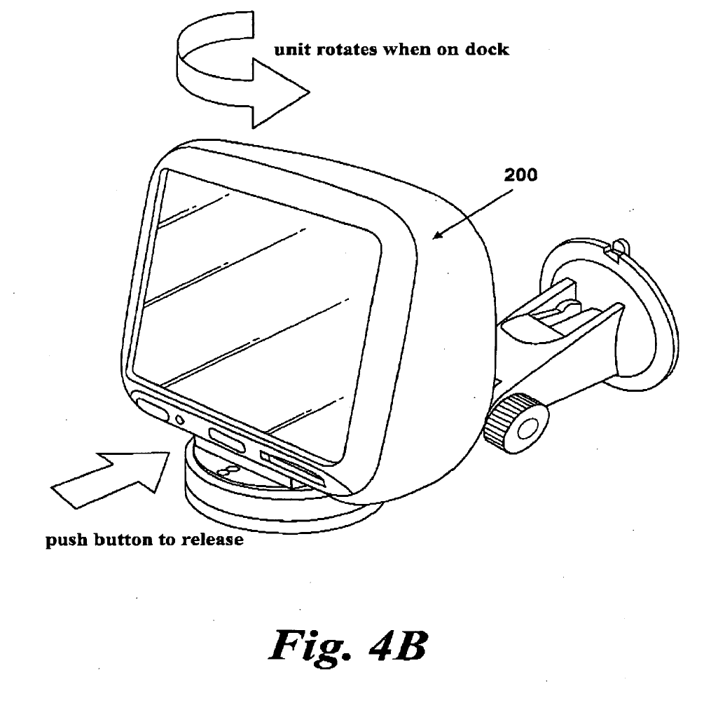

FIGS. 4A and 4B are perspective views of a navigation device 200. As shown in FIG. 4A, the navigation device 200 may be a unit that includes an integrated input and display device 290 (a touch panel screen for example) and the other components of FIG. 2 (including but not limited to internal GPS receiver 250, microprocessor 210, a power supply, memory systems 220, etc.).

The navigation device 200 may sit on an arm 292, which itself may be secured to a vehicle dashboard/window/etc. using a large suction cup 294. This arm 292 is one example of a docking station to which the navigation device 200 can be docked. As shown in FIG. 4B, the navigation device 200 can be docked or otherwise connected to an arm 292 of the docking station by snap connecting the navigation device 292 to the arm 292 for example (this is only one example, as other known alternatives for connection to a docking station are within the scope of the present application). The navigation device 200 may then be rotatable on the arm 292, as shown by the arrow of FIG. 4B. To release the connection between the navigation device 200 and the docking station, a button on the navigation device 200 may be pressed, for example (this is only one example, as other known alternatives for disconnection to a docking station are within the scope of the present application).

Referring to FIG. 5 there is shown a screenshot from a PND or navigation system in which the present invention has been implemented. As can be seen, the screenshot includes a status bar 502 including a variety of navigationally relevant information, a graphical indicator 504 representing the current calculated or approximated device location, and a horizon 506 below which conventional map data is displayed, in this case being one or more roads 508 passing between differently shaded regions 510 representing buildings, countryside or other land. Above the horizon line 506, a graphical visualization of mountains 512 is displayed to give the impression to the user that he is approaching a region of increased elevation at some point remote from the current location. As can also be seen in the Figure, the current road being traveled and along which navigation is currently occurring appears with a different colour or fill level, as is known.

Under normal circumstances where map information is displayed with a 3-dimensional aspect as shown in FIG. 5, the horizon line 506 tends to coincide with the uppermost edge of the device screen, or be very close thereto, so in a preferred embodiment of the invention, the software may actually cause the display of map information in such a manner so as to lower the vertical level of the horizon line 506 relative to the uppermost horizontal edge of the screen such that the graphical visualization of mountains can be displayed above the horizon line as shown. In this manner, the position of the sun, moon, and or stars may also be displayed to provide additional orientation advantages to the user.

The skyline visualization demonstrated by the display of a mountain-like graphical visualizations may help the user orientate himself, particularly if the graphical visualization fairly corresponds to the actual skyline he is, at that time, approaching. An important aspect of the invention is that nearby areas are displayed on-screen in a manner which makes them appear generally flat by comparison, as shown. It is furthermore preferable that elevation data, forming part of or being derived from the underlying map data, is used in the creation of the graphical visualization such that the visualization is a fair representation of the actual elevation profile of the remote landscape, although this not necessarily be the case. For example, if the distant landscape directly ahead is mountainous, and the distant landscape to the left or right of the device is not, and the user makes a left or right turn, the device will automatically create a new graphical visualization indicative of a far less mountainous region in the distance—this feature will automatically enable the user to better and more quickly orientate himself.

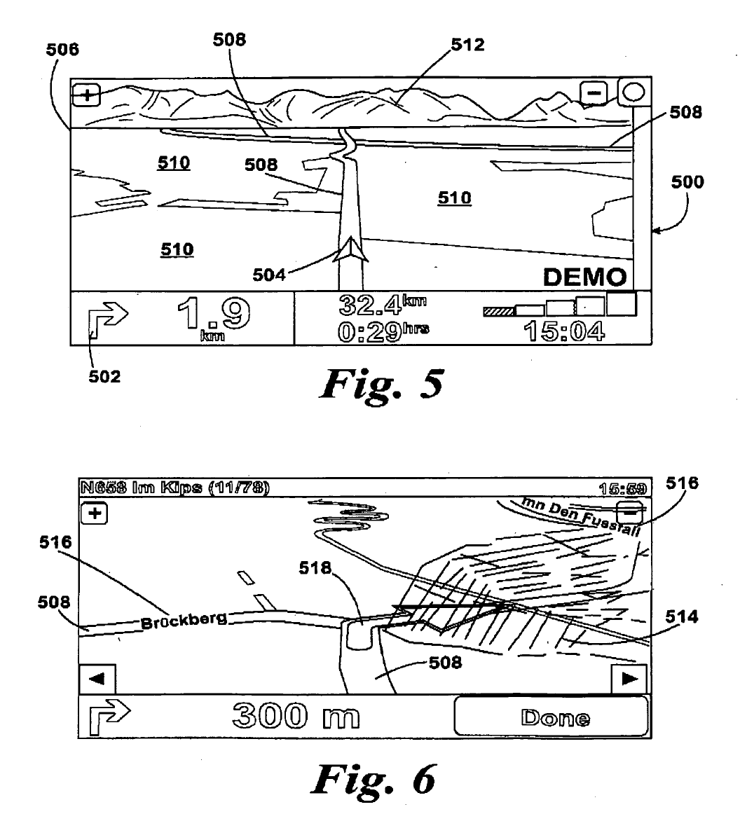

Referring to FIG. 6, an alternative embodiment is shown wherein shading 514 is displayed overlaid on the graphically displayed map data in a region of increased (or possibly decreased) elevation. In this Figure, it can also be seen that the map data displayed is of an increased magnification or zoom level as compared to that shown in FIG. 5, and in particular road names are clearly displayed, the graphically represented roads are of greater on-screen dimensions, and a navigation indicator 518 is clearly displayed in superposed relation to an underlying road junction at which a navigation manouevre must be made by the user to follow the pre-calculated route, which is also clearly marked on-screen by means of the relevant roads forming part of that route being of a different colour to those roads not forming part of the route.

Again, in this embodiment, the on-screen display may provide a notional boundary, translated as may be appropriate to apply to the underlying map data, and within which the device or system obtains elevation data from said underlying map data. In the event that the device or system determines that, within this notional (and continuously changing) boundary, there is a region of land which is of a sufficiently different elevation, or there is a sufficient level of rate of change of elevation, then the processor may apply a predetermined shading, which may be more or less severe or different depending on whether the change (or rate of change) in elevation is more or less severe. Again, such facility provides for increased orientation benefit for the user. In the embodiment shown in this Figure, the map information display is effected in a three-dimensional manner, and the shading applied may be correspondingly displayed so as to be correspondingly gradated, optionally using one or more algorithms implemented in the device or system software used in the display of the map data. Of course, in the event that the map data is displayed on screen in a two-dimensional manner (for which see FIG. 8), the shading or other graphical visualization representative in change in land elevation, may still be displayed, albeit in a flat, non-gradated manner relative to the position of display on the screen of the device.

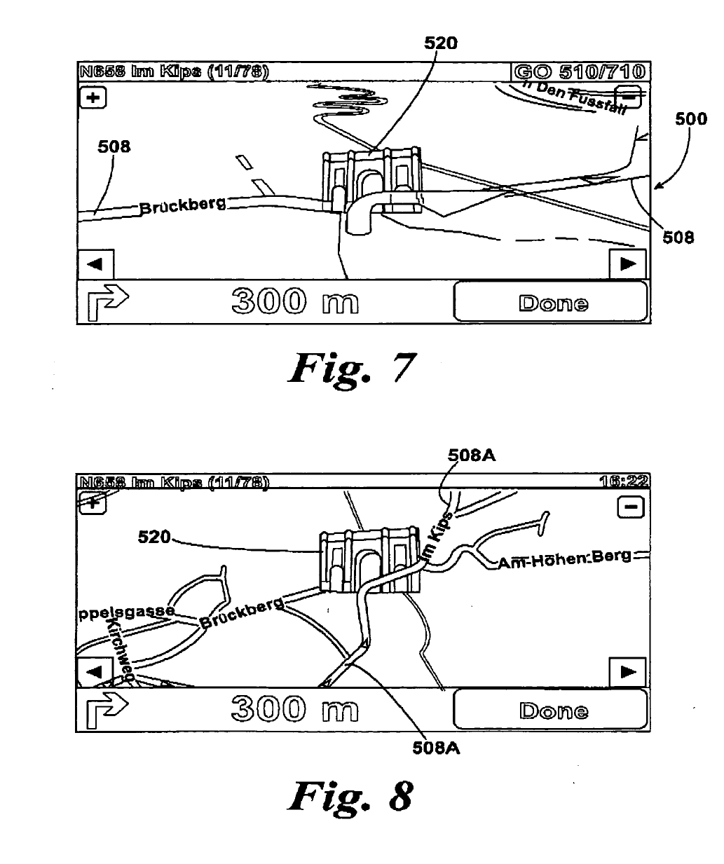

In an alternative (or additional) aspect of the invention, such as represented in FIG. 7, it is also possible for the device or system, when provided not only with basic digital map data but also with additional meta-data, photographic data, vector data, or other data capable of being used to graphically represent a landmark, to display a graphical visualization of that landmark on-screen at the appropriate position relative to the graphically displayed map data. In FIG. 7, it can be seen that a useful graphical visualization is a photographic image 520, optionally blended into the underlying graphically displayed map data to reduce the contrast or prominence of said displayed visualization on-screen and optionally to alter transparency or translucency of said graphical visualization such that underlying graphically displayed map information, or at least the roads forming part of the pre-calculated route, can at least partially still be recognized through the visualization, as shown in FIG. 8. Specifically, the road 508A, or at least the outline thereof, forming part of the pre-calculated route in FIG. 8 can be partially seen through the graphical visualization 520.

Although the visualization shown in FIGS. 7 and 8 is photographic in nature, it may be of course otherwise constituted in the underlying map data or ancillary file applicable thereto, for example from vector or meta-data representing an image of a particular shape corresponding to the actual landmark desired to be represented. Additionally, the invention may extend to alternate perspective processing of the visualization depending on whether the map data is at that time being graphically represented in two or three dimensions, although as can be seen from FIGS. 7 and 8, no such alternate processing has been conducted.

As is immediately evident from FIGS. 7 and 8, the visualization 520, is displayed on-screen such that it can be immediately visually recognized by the user, regardless of the particular displayed map data magnification level or degree of perspective, and in one embodiment, the relative size of the displayed visualization remains constant as perspective or magnification is changed by the user.

In an alternative embodiment, the invention may extend to automatic sizing and re-sizing of the visualization depending on the current zoom, magnification level or perspective. For example, perspective processing may be applied to the visualization in similar manner to the underlying map data or the graphical representation thereof in the event that the user changes the display from two-dimensions to three-dimensions or vice versa. Additionally, size processing may be applied to the visualization in the event that the user changes the degree of magnification of displayed map data, such size processing being dependent on the magnification degree or a parameter stored in memory representative of such, to render the visualization correspondingly smaller or larger as may be required. Additionally, when the map data displayed is below a certain level, for instance when a large scale map is being displayed in a route overview function of the device, the software may preclude display of any graphical visualizations to ensure that the route overview can be clearly comprehended.

In a final aspect of the invention, not specifically illustrated in the Figures, it is additionally possible for the device to display a graphical visualization representative of one or more celestial bodies, such as the sun, moon, or stars, in order to provide the user with further orientation benefits. For example, and particularly when the on-screen display of the device or system includes a horizon line as at 506 in FIG. 5, a graphical visualization of the sun or moon may be displayed above the horizon line, the position of such graphical visualization above said horizon line corresponding to the actual likely position of the sun or moon at that time, the on-screen position thereof being determined from the current global geospatial position and orientation (e.g. in terms of a heading or bearing) of the device, and the time of day. Of course, other skyline, time- and bearing-dependent graphical visualizations may additionally be displayed, such as sunsets and sunrises, both of which can be determined from the parameters mentioned above, and which will also facilitate more rapid and improved user orientation.

What is claimed is:

1. A method of operating a navigation device, said method including the steps of:
representing stored map data visually on a display screen including a graphical representation of a current device location,
determining a boundary distance to at least one of forward and one side of said current location of said device,
determining from map data whether any ancillary elevation or landmark data is available within, or within a predetermined distance of, said boundary distance, such boundary distance optionally being translated as may be appropriate to correspond to map data, and
causing display of one or more graphical visualizations representing elevated features or landmarks in conjunction with said visually represented map data.

2. The method according to claim 1, wherein said display of one or more graphical visualizations is effected when ancillary elevation or landmark data, derived from map data, is at least one of:
within said boundary distance;
within said boundary distance and within a predetermined distance of said current device location; and
outside said boundary distance by a predetermined amount and greater or less than a predetermined elevation level.

3. The method according to claim 1, further comprising the steps of:
providing a horizon level on said screen beneath which map data is visually represented, and
wherein said graphical visualization is applied to said displayed map data above said horizon level appearing on said screen.

4. The method according to claim 3, wherein said graphical visualization comprises forms of mountains.

5. The method according to claim 1, wherein, in an event that elevation data is available for one or more areas or features currently being displayed as part of a visually represented map data and is sufficiently different from elevation of a current location of said device, said graphical visualization comprises shading over and around an area or feature within map data for which elevation data is available.

6. The method according to claim 1, wherein, in an event that landmark data is available for one or more locations being within a region defined by a currently displayed map data, and within a predetermined distance of said current device location, said graphical visualization comprises an icon or other graphical indicator having a shape or otherwise generally being representative of said landmark.

7. The method according to claim 6, wherein said icon or other graphical indicator comprises a shape generally corresponding to an actual landmark shape.

8. The method according to claim 6, further comprising the steps of:
storing photographic data for one or more of the landmarks represented within one or more physical geographic regions covered by said map data in said device, wherein said photographic data forms part of a total map data resource or being discrete therefrom;
displaying said photographic image data on said screen.

9. The method according to claim 8, wherein said photographic image data is sized for a current magnification level of said displayed map data.

10. The method according to claim 8, wherein said photographic image data is sized according to its relative distance from said current location of said device such that said display of such on-screen is relatively small when remote from said current location.

11. The method according to claim 8, further comprising the step of additionally processing said photographic image data such that said image appears at least partially blended into an underlying currently displayed map data.

12. The method according to claim 11, further comprising the step of performing alpha-blending or alpha-compositing techniques on said image such that said image appears at least partially blended into said map data.

13. The method according to claim 1, wherein said landmark data comprises processable shape data having at least one of splines, parameterized sin( ) waves, meta-data and vector data.

14. The method according to claim 1, further comprising the step of storing a set of predefined textures in said device such that said textures may be applied as part of the graphical visualizations displayed on screen.

15. The method according to claim 14, wherein said stored textures comprise at least one or more images of at least one of a forest, a rock, a building, a greenery, a roof and a mountain.

16. A method of operating a navigation device, the method comprising the steps of:
displaying an image of stored map data visually on a display screen, said image including graphical representation of the current device location,
determining a current directional orientation of the device based on recent movement thereof,
determining an approximate position of a celestial body with reference to a current device location and orientation, and
displaying at least one graphical indication on said screen of said device representative of said determined position of said celestial body.

17. A computer program comprising computer program code means adapted to perform the method steps of claim 1 when run on a computer.

18. The computer program as claimed in claim 17 when embodied on or in a computer readable medium.

19. A personal navigation device or navigation system, comprising:
a memory including map data stored therein,
a display screen arranged to display a location image comprising said map data,
GPS signal reception means arranged to receive and output GPS signals,
processing means comprising input means arranged to receive said output GPS signals; processor means arranged to determine said location image can cause said image to be displayed on said screen;
distance determination means arranged to determine a boundary distance to at least one of a forward location and a side location with respect to a current location of said device,
map data determination means arranged to determine from said map data whether any ancillary elevation or landmark data is available within, or within a predetermined distance of, said boundary distance, such distance optionally being translated as may be appropriate to correspond to said map data, and wherein
said device or system is adapted to cause display of one or more graphical visualizations representing elevated features or landmarks in conjunction with visually represented map data.
